(19) United States
(12) Patent Application Publication
(10) Pub. No.: US 2025/0384217 A1
(43) Pub. Date: Dec. 18, 2025

(54) INTEGRATION OF PUBLIC LANGUAGE MODELS AND PRIVATE SERVICES

(71) Applicant: International Business Machines Corporation, Armonk, NY (US)

(72) Inventors: Zhong Fang Yuan, Xi'an (CN); Tong Liu, Xi'an (CN); Han Qiao Yu, Xian (CN); YU XIANG CHEN, Shanghai (CN); Hai Bo Zou, Beijing (CN)

(21) Appl. No.: 18/745,222

(22) Filed: Jun. 17, 2024

(51) Int. Cl. G06F 40/40

(52) U.S. Cl. CPC G06F 40/40

(57) ABSTRACT

A method of this disclosure may comprise receiving a task described at least in part with natural language; instructing a public language model to split the task into a plurality of sub-tasks based on a capability of an operation pool which includes a plurality of private services, and to pair the plurality of sub-tasks with respective private services; and instructing the respective private services to perform the plurality of sub-tasks so as to complete the task.

### BACKGROUND

The present invention relates to computer science, and more specifically, to artificial intelligence.

Natural language processing (NLP) refers to a branch of artificial intelligence (AI) concerned with giving computers the ability to understand text and spoken words in much the same way human beings can. In recent years, large language models (LLMs) are widely used for NLP. LLMs are a category of foundation models trained on immense amounts of data making them capable of understanding and generating natural language to perform a wide range of tasks.

### SUMMARY

According to one embodiment of the present disclosure, there is provided a computer-implemented method. The method may comprise receiving a task described at least in part with natural language. The method may further comprise instructing a public language model to split the task into a plurality of sub-tasks based on a capability of an operation pool which includes a plurality of private services, and to pair the plurality of sub-tasks with respective private services. The method may further comprise instructing the respective private services to perform the plurality of sub-tasks so as to complete the task. According to this embodiment, a symbiotic integration of the public language model and local services can be achieved.

According to some embodiments, the task may be further described with multimodal information. Further, the public language model may include a Multimodal Large Language Model (MLLM). According to these embodiments, multimodal task processing may be supported.

According to some embodiments, the capability of the operation pool may be composed of capabilities of the plurality of private services. Further, the capabilities of the plurality of private services may not be overlapped from each other. According to these embodiments, there will be no overlap on capabilities of each of the private services, such that the performance of splitting of the task by the public language model may be improved.

According to some embodiments, the method may further comprise indicating the capability of the operation pool to the public language model by describing functions of each of the plurality of private services with natural language. According to these embodiments, it may facilitate the public language model to understand the functions of the private services to perform the splitting and pairing.

According to some embodiments, the method may further comprise instructing the public language model to generate an execution order of the respective private services based on dependency relations of the private services. Further, the plurality of sub-tasks may be performed by the respective private services based on the execution order. According to these embodiments, the task may be completed in a more efficient execution flow.

According to some embodiments, the execution order may be represented by a Directed Acyclic Graph (DAG) generated by the public language model. Further, each node of the DAG may correspond to a private service with a state variable indicating an execution state of the private service. An edge between two nodes of the DAG may correspond to a dependency relation between two respective private services. According to these embodiments, the representation of the execution order may be improved.

According to some embodiments, the DAG may be generated based on a Bayesian network model. According to these embodiments, the DAG may be dynamically and efficiently generated.

According to another embodiment of the present invention, there is provided a system which may comprise one or more processors and a memory coupled to at least one of the one or more processors. The system may comprise a set of computer program instructions stored in the memory and executed by at least one of the one or more processors in order to perform an action of receiving a task described at least in part with natural language. The system may comprise a set of computer program instructions stored in the memory and executed by at least one of the one or more processors in order to perform an action of instructing a public language model to split the task into a plurality of sub-tasks based on a capability of an operation pool which includes a plurality of private services, and to pair the plurality of sub-tasks with respective private services. The system may comprise a set of computer program instructions stored in the memory and executed by at least one of the one or more processors in order to perform an action of instructing the respective private services to perform the plurality of sub-tasks so as to complete the task. According to this embodiment, a symbiotic integration of the public language model and local services can be achieved.

According to a further embodiment of the present disclosure, there is provided a computer program product. The computer program product may comprise a computer readable storage medium having program instructions embodied therewith. The program instructions may be executable by a device to perform a method. The method may comprise receiving a task described at least in part with natural language. The method may further comprise instructing a public language model to split the task into a plurality of sub-tasks based on a capability of an operation pool which includes a plurality of private services, and to pair the plurality of sub-tasks with respective private services. The method may further comprise instructing the respective private services to perform the plurality of sub-tasks so as to complete the task. According to this embodiment, a symbiotic integration of the public language model and local services can be achieved.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows an exemplary computing environment which is applicable to implement the embodiments of the present disclosure;

FIG. 2 shows an exemplary diagram of an integration of LLM and private services according to some embodiments of the present disclosure;

FIG. 3 shows a flow chart of an exemplary method for integration of public language models and private services according to some embodiments of the present disclosure;

FIG. 4 shows an exemplary diagram of generating a directed acyclic graph (DAG) based on a Bayesian network model according to some embodiments of the present disclosure.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code for integration of public language models and private services 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

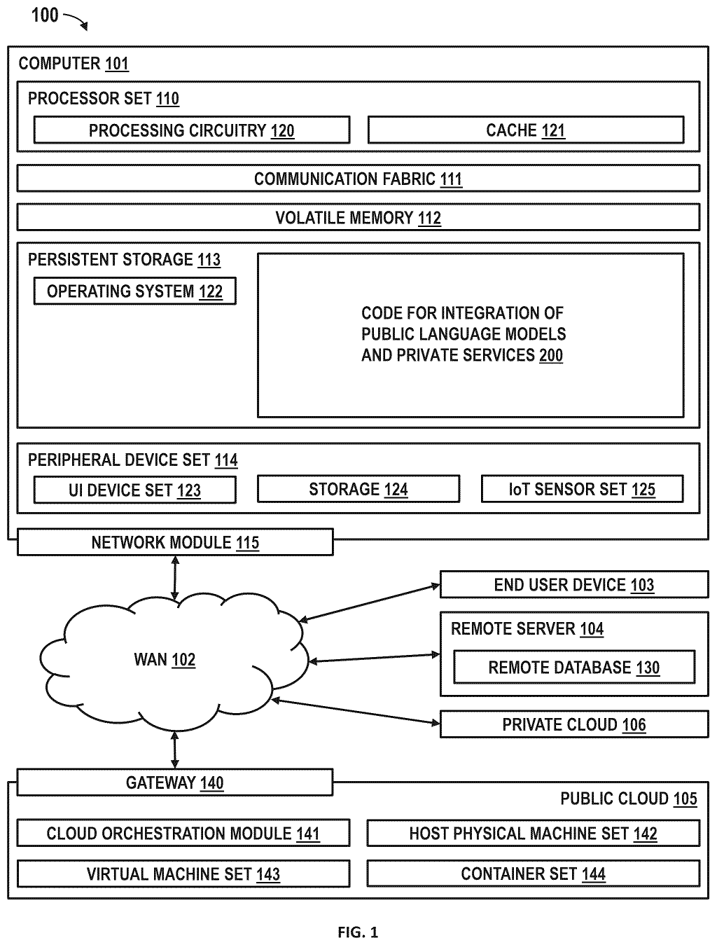

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

It is understood that the computing environment 100 in FIG. 1 is only provided for illustration purpose without suggesting any limitation to any embodiment of this invention, for example, at least part of the program code involved in performing the inventive methods could be loaded in cache 121, volatile memory 112 or stored in other storage (e.g., storage 124) of the computer 101, or at least part of the program code involved in performing the inventive methods could be stored in other local or/and remote computing environment and be loaded when needed. For another example, the peripheral device 114 could also be implemented by an independent peripheral device connected to the computer 101 through interface. For a further example, the WAN may be replaced and/or supplemented by any other connection made to an external computer (for example, through the Internet using an Internet Service Provider).

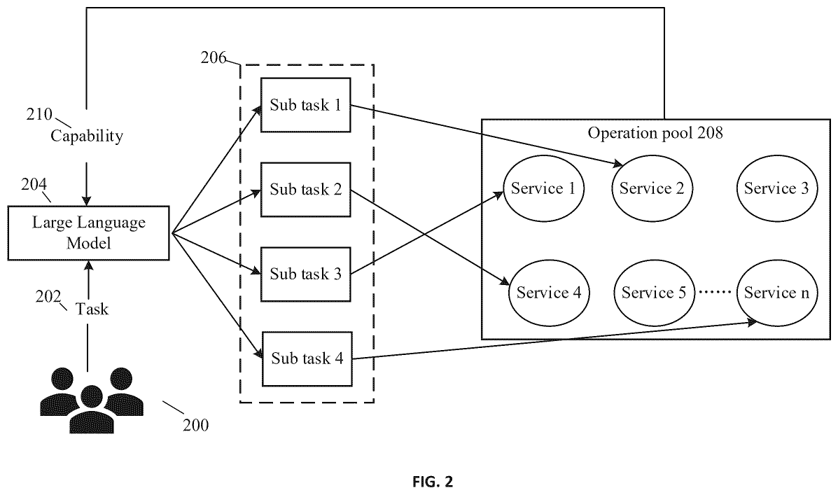

With reference now to FIGS. 2˜4, some embodiments of the present disclosure will be described below.

Public language models such as LLMs may be used for understanding and generating natural language to perform a wide range of tasks. However, although LLMs have powerful capabilities for natural language processing, the inventors of the present disclosure have noticed that there are some defects regarding the usage of LLMs.

In one aspect, LLMs in the industry are typically run as a Model-as-a-Service (MaaS) on cloud servers, due to intellectual property protection and operational cost considerations. However, in industries such as banking, finance, and government, clients may not select such public models due to data privacy concerns but opt for small-scale language models running locally instead. Unfortunately, due to parameter capacity limitations, the effectiveness of small-scale language models often falls short when compared to their larger counterparts.

In another aspect, LLMs may encounter problems related to token length limitations when executing specific tasks. For example, Chat GPT-4, which is an LLM-based system developed by Open AI, supports a maximum context length for input (i.e., the token length) of 32K. Although it is relatively long compared to other LLMs, the token length is still limited. The limitation of maximum token length constrains the broader application of LLMs.

In a further aspect, LLMs trained on public data may fall prey to answering irrelevant questions when used in domain-specific knowledge Q&A. Additionally, due to the high costs associated with training and maintaining large models, it is difficult to make corrective measures at the model level once such an issue arises. Instead, developers may have to rely on prompt engineering methods to indirectly correct the errors after discovery. Unfortunately, the constant emergence of new issues has resulted in a significant workload for prompt template writing and maintenance.

On the other hand, the inventors of the present disclosure have noticed that private services/applications that run locally in enterprises have some advantages that may complement the defects of LLMs.

For example, these services can be deployed locally and privately without data security concerns. Further, they may have a wide range of uses and strong customization capabilities. In addition, since the services may be flexibly customized according to actual needs, there may be no limit on the length of the input content. Further, the services may be refined in some specific fields to obtain powerful capabilities in such fields.

However, these localized private services may still have their own defects. For example, they may have poor adaptability and migration capability. Further, they may not have the ability to handle complex tasks, due to the small scale compared to LLMs.

By weighing up the pros and cons of public language models and private services, it is proposed a solution to integrate the public language models and the private services. The public language model may act as a brain to split a proposed task into a series of sub-tasks and select corresponding private services to pair with the sub-tasks. Further, the selected private services execute the split sub-tasks respectively to complete the task. With the symbiotic integration according to the present disclosure, advantages of both public language models and private services may be brought out while defects thereof may be complemented.

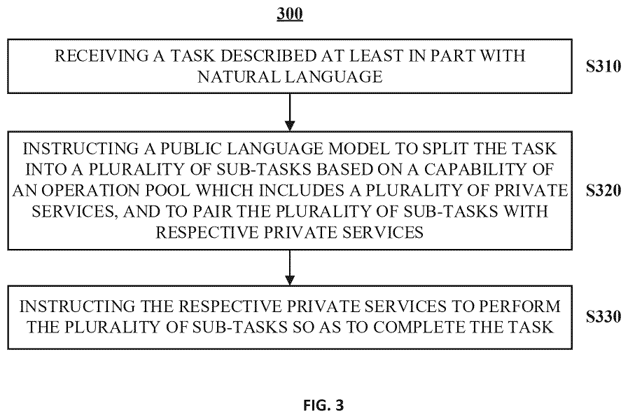

The integration of public language models and private services according to some embodiments of the present disclosure may be further explained by referring to FIGS. 2 and 3.

FIG. 2 shows an exemplary diagram of an integration of LLM and private services according to some embodiments of the present disclosure.

As shown in FIG. 2, a user 200 proposes a task 202 to LLM 204, e.g., by inputting text or spoken words of such task through an interactive interface.

LLM 204 splits the task 202 into a plurality of sub-tasks 206, e.g., sub-tasks 1˜4 based on capability 210 from an operation pool 208. The operation pool 208 includes a plurality of locally deployed private services 1˜n. For each service, it may have a single capability of perform an action to provide a corresponding service. Capability 210 may indicate the capabilities of all services included in the operation pool 208. By referring to capability 210, LLM 204 may understand what actions can be done by the respective services in the operation pool 208, and thus decide how to split the task 202.

Further, LLM 204 pairs the split sub-tasks with respective services to form “sub-task and service” pairs. Accordingly, the services in the operation pool, e.g., service 1, 2, 4 and n as shown in FIG. 2, are chosen by LLM 204 to perform the sub-tasks 1˜4 respectively, so as to accomplish the task 206.

According to the integration of LLM and private services, LLM 204 acts as the brain to split the task 202 and perform task pairing with private services without accessing data of the private services, while the private services execute the sub-tasks by following the brain's thoughts. That is, LLM 204 is only responsible for thinking not for execution, while the private services are only responsible for execution not for thinking. Accordingly, all operations that involve data and privacy may be completed by private services, which may be highly secure localized applications so as to achieve data security and privacy. Meanwhile, the ability to handle complex tasks may also be achieved since the tasks are analyzed by LLMs having powerful NLP capabilities.

The above-described FIG. 2 shows an exemplary integration of the LLM and private services. It is noted that, the public language model of the present disclosure may not be limited to LLM, but may be other types of public language models. Further, “public” language model in the present disclosure means that the language model is available for use by multiple entities that provides on-demand availability of natural language processing capabilities. In contrast, “private” services in the present disclosure means that the services are locally deployed for use by a single entity, such as local applications, software, etc.

Now refer to FIG. 3, which shows a flow chart of an exemplary method for integration of public language models and private services according to some embodiments of the present disclosure.

As shown in FIG. 3, in some embodiments, in S310 of FIG. 3, one or more processors may receive a task described at least in part with natural language. The task may correspond to task 202 in FIG. 2. As an example, the task may be “initiate an approval process” input by the user.

It should be noted that the task described with natural language may not be limited to text input, but may also be spoken input or other forms, as long as it can be used to convey semantic information of the task to the processors.

Next, in S320, the one or more processors may perform task splitting and pairing. Specifically, the one or more processors may instruct a public language model to split the task into a plurality of sub-tasks based on a capability of an operation pool which includes a plurality of private services, and to pair the plurality of sub-tasks with respective private service.

The public language model may correspond to LLM 204 of FIG. 2. Examples of public language models may include but not limited to Open AI's Chat GPT-3 and GPT-4, Meta's Llama models and Google's bidirectional encoder representations from transformers (BERT/ROBERTa) and PaLM models.

Further, the operation pool is a collection of services that can be thought of as privately deployed services, which may correspond to operation pool 208 of FIG. 2 including services 1˜n.

Now, let's discuss how to configure the private services to build the operation pool.

In some embodiments, the services may be configured based on the following rules.

For rule 1, for each service, the function of the service may be described with natural language in association with the respective service, so that the public language model will understand the capability of the service by referring to the described function, so as to facilitate the splitting of the task.

For rule 2, in addition or alternatively, input and output of each service may be defined, so that the public language model will know dependencies of the services to determine an order for sequentially executing the sub-tasks by respective services.

For rule 3, in addition or alternatively, the plurality of private services may be configured to provide non-overlapped services from each other. In other words, the capability of each service is not overlapped with another service. By such configuration, the private services may have clear and independent task boundaries. Accordingly, it may become easier for the public language model to split the task and choose respective services to perform the split sub-tasks, so as to improve the performance of task splitting and pairing.

For any service, it can be standardized based on the above rules and be organized into the operation pool according to actual needs. The following shows 9 exemplary services included in the operation pool, in which functions, inputs and outputs are defined.

Service 1:

Function: Create a link in the box and return this link
Input: action1_input
Output: box_url

Service 2:

Function: Continuously monitor whether there is a
docx file in the box, and return the corresponding
return value
Input: box_url, time_sheet
Output: status_code

Service 3:

Function: Read the docx file on the box and parse it
into a byte stream
Input: box_url
Output: byte_stream

Service 4:

Function: Read the docx byte stream and extract all the
unreviewed people in it
Input: byte_stream
Output: review_info

Service 5:

Function: Send information to users on slack and allow
users to modify information
Input: review_info
Output: review_info_update

Service 6:

Function: Send an email to the specified recipient and
return a status code
Input: review_info_update, email
Output: status_code

Service 7:

Function: Generate an email to urge those who have
not reviewed it to approve it quickly
Input: review_info_update
Output: email_text

Service 8:

Function: Call the OCR interface to convert pictures
into text
Input: image
Output: txt

Service 9:

Function: Call the math interface to calculate the sum
of two numbers
Input: num1, num2
Output: num3

In some embodiments, in S320, the one or more processors may instruct the public language model to perform the task splitting and pairing, for example, with a natural language instruction “What you have to do is to initiate an approval process. Any choice you make must be within the capability of the operation pool”, in which the task “initiate an approval process” is obtained in S310. Accordingly, the public language model may access the operation pool to acquire the capability of the operation pool and then perform the task splitting and pairing in consideration of the capability of the operation pool.

In some embodiments, an identity may be set for the public language model so that the public language model will understand the task more clearly. For example, the public language model may be further instructed with an instruction “You are a robot for approval, you can understand the tasks, and break them down into different tasks, and revoke corresponding services to complete the task” for identity setting.

It should be understood that prompt engineering methods such as prompt templates may be used for instructing the public language model to perform the proposed tasks.

In some embodiments, the capability of the operation pool may be composed of capabilities of the plurality of private services. In some embodiments, the capability of the operation pool may be indicated to the public language model by describing functions of each of the plurality of private services with natural language. Further, the public language model may review the functions of the services in the operation pool to know what actions can be done by those services and then perform the splitting and pairing based on this knowledge.

For example, based on the natural language instruction “What you have to do is to initiate an approval process. Any choice you make must be within the capability of the operation pool”, the public language model may split the task “initiate an approval process”, by referring to the capability of the operation pool (for example, the functions of the above services 1˜9 included in the operation pool), into sub-tasks 1˜7 including sub-task 1 “create a link in a box”, sub-task 2 “monitor files in the box”, sub-task 3 “read the file on the box”, sub-task 4 “extract unreviewed people from the file”, sub-task 5 “allow modification”, sub-task 6 “generate an email to urge the unreviewed people”, sub-task 7 “send an email”.

Further, task pairing is performed. In some embodiments, the pairing may be achieved by comparing the sub-tasks with the functions of the services in the operation pool to find a match between a sub-task and a service which is able to execute the sub-task. For the above example, the sub-tasks 1˜7 may be paired with services 1˜7 in the operation pool respectively. That is, services 1˜7 are chosen by the public language model from the operation pool for executing the task.

In some embodiments, since the task splitting may be performed in consideration of the capabilities of the services, the task splitting and pairing may be performed simultaneously to determine the “sub-task and service” pairs.

Next, in S330, the one or more processors may instruct the respective private services to perform the plurality of sub-tasks so as to complete the task. For example, services 1˜7 may be instructed to perform respective sub-tasks 1˜7 to accomplish the task “initiate an approval process”.

In some embodiments, application programming interfaces (APIs) of the private services may also be configured in the operation pool, so that the chosen services may be easily revoked. In some embodiments, the one or more processors may instruct the public language model to revoke the chosen services to perform the sub-tasks. It is noted that the private services may not have natural processing abilities because they only have to perform the actions of their own to complete the sub-tasks without further analyzing the sub-tasks.

According to the integration method 300 of the present disclosure, the following technical effects may be achieved.

The public language model is only responsible for thinking not for execution, while the private services is only responsible for execution not for thinking. Therefore, all operations that involve data and privacy may be completed by private services, which may be highly secure localized applications so as to achieve data security and privacy. Meanwhile, the ability to handle complex tasks may also be achieved since the tasks are analyzed by public language model having NLP capabilities.

Further, there may be no token length limit in task execution. The public language model is only responsible for the core part of the task, which can be broken down into independent parts in the form of a mind map, without requiring an excessively long context.

In addition, due to the flexibility of the private services, the task processing capability may be highly customizable. For example, various services may be configured in the operation pool for executing different tasks according to business requirements. Further, private services in some specific fields may be configured in the operation pool to handle tasks in these fields. In addition, the private services may be updated and iterated quickly to maintain the flexibility, and new services may be easily added in the operation pool to fulfill demands of new tasks.

Further, since it is not necessary for the locally deployed private services to have powerful natural language processing abilities, local computer system resources for data storage and computing power may be saved. In some embodiments, the integration method 300 may be performed in the local computer system, which receives task input from the user, and sends instructions to the public language model to perform task splitting and pairing, and then performs the respective local private services to complete the task. In these embodiments, since the training and inference of the public language model which may be resource-consuming are not performed on the local computer system, the integration method 300 may be simply migrated in any local computer system without requiring the ability to provide high storage and computing performance.

In the above embodiments, the task is described with natural language. Further, in some embodiments, the task may be further described with multimodal information. The multimodal information includes different modalities of data including not only written text and spoken language, but also visual data such as images and videos, numeric data, and sensor data, among others. In these embodiments, the public language model may include a Multimodal Large Language Model (MLLM) which is trained using different modalities of data and may have the ability to understand multimodal information in a similar way as human beings. For example, MLLM may convert multimodal information into natural language for subsequent processing. Therefore, MLLM may be instructed to perform task splitting and pairing in a similar way as the previously described LLM.

Next, an execution order of the selected private services will be discussed.

In some scenarios, there may be dependencies among the selected private services. For example, service 7, which functions as “generate an email to urge those who have not reviewed it to approve it quickly”, may have to be performed after the completion of service 6, which functions as “send an email to the specified recipient and return a status code”. Therefore, an execution order of the selected private services may be further generated to further improve the performance of the integration method 300 of the present disclosure.

In some embodiments, in the integration method 300, the one or more processors may instruct the public language model to generate an execution order of the respective private services based on dependency relations of the private services. Further, the plurality of sub-tasks may be performed by the respective private services based on the execution order. For example, the public language model may be instructed by a natural language instruction “organize the approval process into an executable flow”. Then, the public language model will generate an execution order for the private services. Taking the selected services 1˜7 as an example, based on their dependency relations, the execution order will be sequentially executing service 1 to service 7.

By considering dependency relations of the private services, the private services may be performed according to the execution order in a more efficient way to accomplish the task.

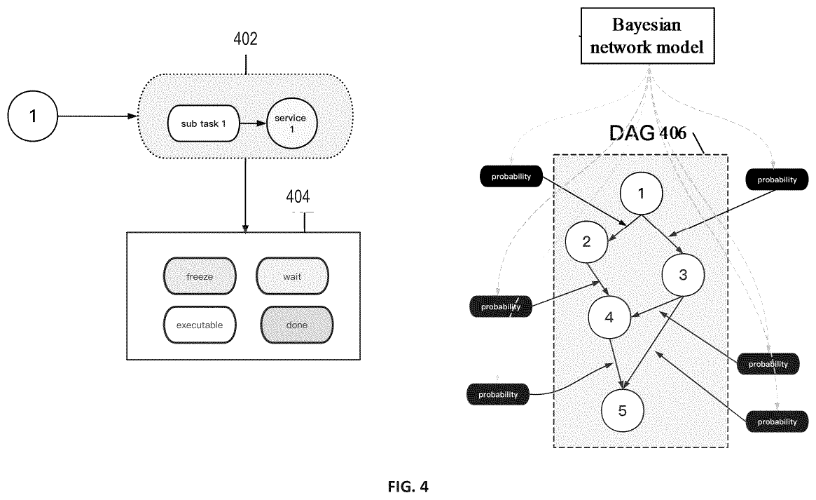

Now refer to FIG. 4, which shows an exemplary diagram of generating a directed acyclic graph (DAG) based on a Bayesian network model according to some embodiments of the present disclosure.

In some embodiments, the execution order may be represented by the DAG based on a Bayesian network model. The Bayesian network model is a probabilistic graphical model, which represents conditional independence relationships between a set of state variables by the DAG.

In the DAG, each node corresponds to a private service with a state variable indicating an execution state of the private service. As shown in FIG. 4, node 1 corresponds to the “sub-task and service” pair 402 including sub task 1 and service 1 shown in FIG. 2, i.e., node 1 corresponds to service 1. For each service derived from the public language model in S320, it may form a node in the DAG 406. FIG. 4 shows five nodes 1˜5 corresponding to five private services which are split and paired by the public language model in S320. The number of nodes in the DAG is equal to the number of sub-tasks.

There may be four possible states 404 for each node in the DAG: “freeze”, “wait”, “executable”, and “done”. “Freeze” indicates that the node does not yet have the conditions for execution, for example, input is not ready or resources are unavailable. “Wait” indicates that the node has obtained some conditions for execution, but the execution conditions are not yet fully ready. “Executable” indicates that the node has obtained sufficient resources and input, and has the conditions for execution. “Done” indicates that the sub-task represented by the node has been completed. For each node in the DAG, the state variable may be determined according to the states 404. These state variables will become nodes in the Bayesian network.

Further, in the DAG, an edge between two nodes corresponds to a dependency relation between two respective private services. The dependency relation may include but not limited to serial, parallel, dependency, backtracking, etc. In the DAG, the dependency relation between nodes may be represented by the direction of the edge. For example, as can be seen from the edges in DAG 406, an edge from node 3 to node 4 indicates that node 4 depends on node 3, and an edge from node 3 to node 5 indicates that node 5 also depends on node 3, etc. By connecting the node and its dependent nodes in the DAG, the dependency structure of the nodes may be reflected in the DAG.

Further, for each node, the conditional probability distribution of its state variable is determined. These conditional probability distributions will be modeled based on the node's dependency relationship and contextual information (e.g., function, input and output of the service), considering the conditional and prior knowledge of node states, as well as the correlation with the states of other nodes.

Further, historical data on node execution and state changes are collected and used for estimating parameters of the conditional probability distributions in the Bayesian network model. Based on the collected data and defined conditional probability distributions, the parameters may be estimated.

Then, the Bayesian network model may be used for inference and prediction. Given the current state of the node and contextual information, the Bayesian network model may be used to calculate the posterior probability distribution of the node state. Based on the posterior probability distribution, the next state of the node can be predicted.

Finally, based on the inference results of node states, scheduling decisions for node execution may be made. Considering the dependency relations of nodes, the execution order of nodes can be determined, that is, which nodes can be executed, and which nodes need to wait or be frozen. Accordingly, the execution order of the chosen private services may be generated dynamically with efficiency.

In some embodiments, the one or more processors may instruct the public language model to generate the execution order in the form of DAG based on a Bayesian network model, and the private services deployed in the local computer system may perform respective sub-tasks according to the execution order returned by the public language model. Further, in some other embodiments, the Bayesian network model-based DAG may be constructed in the local computer system to determine the execution order of the private services.

It should be noted that the processing of integration of public language models and private services according to embodiments of this disclosure could be implemented in the computing environment of FIG. 1.

The present invention may be a system, a method, and/or a computer program product at any possible technical detail level of integration. The computer program product may include a computer readable storage medium (or media) having computer readable program instructions thereon for causing a processor to carry out aspects of the present invention.

According to an embodiment of the present disclosure, there is provided a system for integration of public language models and private services. The system may comprise one or more processing units and a memory coupled to at least one of the one or more processing units. The system may further comprise a set of computer program instructions stored in the memory and executed by at least one of the one or more processing units in order to perform actions including receiving a task described at least in part with natural language; instructing a public language model to split the task into a plurality of sub-tasks based on a capability of an operation pool which includes a plurality of private services, and to pair the plurality of sub-tasks with respective private services; and instructing the respective private services to perform the plurality of sub-tasks so as to complete the task.

According to an embodiment of the present disclosure, there is provided a computer program product. The computer program product may comprise a computer readable storage medium having program instructions embodied therewith. The program instructions may be executable by a device to perform a method. The method may comprise receiving a task described at least in part with natural language; instructing a public language model to split the task into a plurality of sub-tasks based on a capability of an operation pool which includes a plurality of private services, and to pair the plurality of sub-tasks with respective private services; and instructing the respective private services to perform the plurality of sub-tasks so as to complete the task.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving a task described at least in part with natural language;
instructing a public language model to split the task into a plurality of sub-tasks based on a capability of an operation pool which includes a plurality of private services, and to pair the plurality of sub-tasks with respective private services; and
instructing the respective private services to perform the plurality of sub-tasks so as to complete the task.

2. The computer-implemented method of claim 1, wherein the task is further described with multimodal information, and wherein the public language model includes a Multimodal Large Language Model (MLLM).

3. The computer-implemented method of claim 1, wherein the capability of the operation pool is composed of capabilities of the plurality of private services, and the capabilities of the plurality of private services are not overlapped from each other.

4. The computer-implemented method of claim 3, wherein the method further comprises:
indicating the capability of the operation pool to the public language model by describing functions of each of the plurality of private services with natural language.

5. The computer-implemented method of claim 1, wherein the method further comprises:
instructing the public language model to generate an execution order of the respective private services based on dependency relations of the private services; and
wherein the plurality of sub-tasks are performed by the respective private services based on the execution order.

6. The computer-implemented method of claim 5, wherein the execution order is represented by a Directed Acyclic Graph (DAG) generated by the public language model, each node of the DAG corresponding to a private service with a state variable indicating an execution state of the private service, and an edge between two nodes of the DAG corresponding to a dependency relation between two respective private services.

7. The computer-implemented method of claim 6, wherein the DAG is generated based on a Bayesian network model.

8. A system comprising:
one or more processors;
a memory coupled to at least one of the one or more processors;
a set of computer program instructions stored in the memory and executed by at least one of the one or more processors in order to perform actions of:
receiving a task described at least in part with natural language;
instructing a public language model to split the task into a plurality of sub-tasks based on a capability of an operation pool which includes a plurality of private services, and to pair the plurality of sub-tasks with respective private services; and
instructing the respective private services to perform the plurality of sub-tasks so as to complete the task.

9. The system of claim 8, wherein the task is further described with multimodal information, and wherein the public language model includes a Multimodal Large Language Model (MLLM).

10. The system of claim 8, wherein the capability of the operation pool is composed of capabilities of the plurality of private services, and the capabilities of the plurality of private services are not overlapped from each other.

11. The system of claim 10, wherein the actions further comprise:
indicating the capability of the operation pool to the public language model by describing functions of each of the plurality of private services with natural language.

12. The system of claim 8, wherein the actions further comprise:
instructing the public language model to generate an execution order of the respective private services based on dependency relations of the private services, and
wherein the plurality of sub-tasks are performed by the respective private services based on the execution order.

13. The system of claim 12, wherein the execution order is represented by a Directed Acyclic Graph (DAG) generated by the public language model, each node of the DAG corresponding to a private service with a state variable indicating an execution state of the private service, and an edge between two nodes of the DAG corresponding to a dependency relation between two respective private services.

14. The system of claim 13, wherein the DAG is generated based on Bayesian network.

15. A computer program product comprising a computer readable storage medium having program instructions embodied therewith, wherein the program instructions being executable by a device to perform a method comprising:
receiving a task described at least in part with natural language;
instructing a public language model to split the task into a plurality of sub-tasks based on a capability of an operation pool which includes a plurality of private services, and to pair the plurality of sub-tasks with respective private services; and
instructing the respective private services to perform the plurality of sub-tasks so as to complete the task.

16. The computer program product of claim 15, wherein the task is further described with multimodal information, and wherein the public language model includes a Multimodal Large Language Model (MLLM).

17. The computer program product of claim 15, wherein the capability of the operation pool is composed of capabilities of the plurality of private services, and the capabilities of the plurality of private services are not overlapped from each other.

18. The computer program product of claim 17, wherein the method further comprises:
indicating the capability of the operation pool to the public language model by describing functions of each of the plurality of private services with natural language.

19. The computer program product of claim 15, wherein the method further comprises:
instructing the public language model to generate an execution order of the respective private services based on dependency relations of the private services; and
wherein the plurality of sub-tasks are performed by the respective private services based on the execution order.

20. The computer program product of claim 19, wherein the execution order is represented by a Directed Acyclic Graph (DAG) generated by the public language model, each node of the DAG corresponding to a private service with a state variable indicating an execution state of the private service. and an edge between two nodes of the DAG corresponding to a dependency relation between two respective private services.
